(19) United States
(12) Patent Application Publication
(10) Pub. No.: US 2007/0175300 A1
(43) Pub. Date: Aug. 2, 2007

(54) ADJUSTABLE WRENCH

(76) Inventors: James M. Burry, Troutman, NC (US); Brett Lucus, Huntersville, NC (US); Thomas M. Chervenak, Huntersville, NC (US)

Correspondence Address: MOORE & VAN ALLEN PLLC, P.O. BOX 13706, Research Triangle Park, NC, 27709, US

(21) Appl. No.: 11/461,538

(22) Filed: Aug. 1, 2006

Related U.S. Application Data
(60) Provisional application No. 60/704,564, filed on Aug. 2, 2005.

(51) Int. Cl. B25B 13/22

(52) U.S. Cl. 81/145; 81/142

(57) ABSTRACT

The wrench comprises a body that includes a handle that supports a fixed jaw. The body further includes a passage for receiving a movable jaw. A movable jaw includes an engagement portion that is slidably received in the passage such that the movable jaw is able to slide in the passage relative to the fixed jaw. The movable jaw includes a series of ratchet teeth. The ratchet teeth are arranged such that the distal ends of the teeth are in a plane where the plane is at an oblique angle with respect to the direction of movement of the movable jaw. The engagement faces of the teeth are perpendicular to the plane. A ratcheting locking mechanism is provided that prevents movement of the jaws away from one another but allows movement of the jaws towards one another.

This application claims the benefit of priority under 35 U.S.C. § 119(e) to the filing date of U.S. Provisional Application 60/704,564 filed on Aug. 2, 2005, which is incorporated herein by reference in its entirety.

### BACKGROUND

The invention relates generally to an adjustable wrench and more particularly to a quick-adjust adjustable wrench where the jaws can be quickly and easily moved into and out of engagement with an article to be gripped.

It will be appreciated that many different types of wrenches are known including adjustable wrenches. Adjustable wrenches typically comprise a handle supporting a fixed jaw. A movable jaw is supported on the handle/fixed jaw such that it can move towards and away from the fixed jaw. By adjusting the distance between the fixed and movable jaws, the wrench can grip a range of fastener sizes. One common mechanism for moving the movable jaw is a knurled screw supported on the handle/fixed jaw that engages a rack on the movable jaw. Adjustable wrenches provide the benefit of being able to be used on a variety of different types and sizes of fasteners. One limitation of adjustable wrenches is that it is often necessary to adjust and seat the wrench on the fastener, turn the fastener a partial turn, remove the wrench from the fastener, readjust and reseat the wrench on the fastener and repeat the process where the readjustment of the wrench using a screw can be time consuming and cumbersome to use in some applications.

Thus, an improved adjustable wrench is desired.

### SUMMARY OF THE INVENTION

The wrench comprises a body that includes a handle that supports a fixed jaw. The body further includes a transition area that connects the handle to the fixed jaw where the transition area includes a passage for receiving a movable jaw. The passage may be formed as a cavity in the body that extends transversely through the transition area. The passage communicates with a through hole that retains the jaw locking mechanism. A movable jaw includes an engagement portion that is slidably received in the passage such that the movable jaw is able to slide in the passage relative to the fixed jaw. The movable jaw includes a series of ratchet teeth. The ratchet teeth are arranged such that the distal ends of the teeth are in a plane where the plane is at an oblique angle with respect to the direction of movement of the movable jaw. A locking mechanism is located in through hole such that it can reciprocate in the through hole. Specifically, the locking mechanism can move in a direction that is approximately perpendicular to the direction of movement of the movable jaw. The locking mechanism includes ratchet teeth at the upper edge thereof that are dimensioned to mate with teeth formed on the movable jaw. The locking mechanism is biased into engagement with the movable jaw. The back faces of the ratchet teeth are sloped such that the teeth can slide over one another in a ratcheting action when the movable jaw is pushed toward the fixed jaw.

### BRIEF DESCRIPTION OF THE DRAWINGS

FIG. 1 is a section view of one embodiment of the wrench of the invention taken along line 1-1 of FIG. 5.

FIG. 2 is a partially exploded perspective view of one embodiment of the wrench of the invention.

FIG. 3 is a plan view of one embodiment of the wrench of the invention.

FIG. 4 is right side view of the wrench of FIG. 3.

FIG. 5 is a left side view of the wrench of FIG. 3.

FIG. 6 is a section view similar to FIG. 1 showing the wrench in greater detail.

### DETAILED DESCRIPTION OF ONE EMBODIMENT OF THE INVENTION

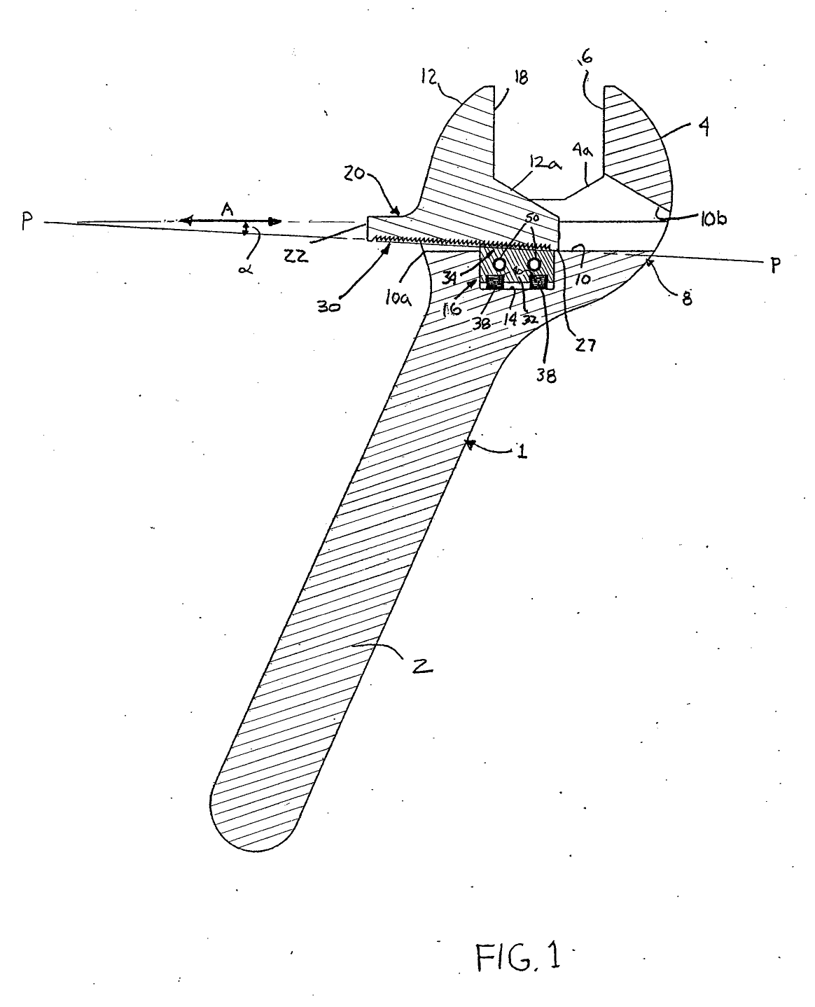

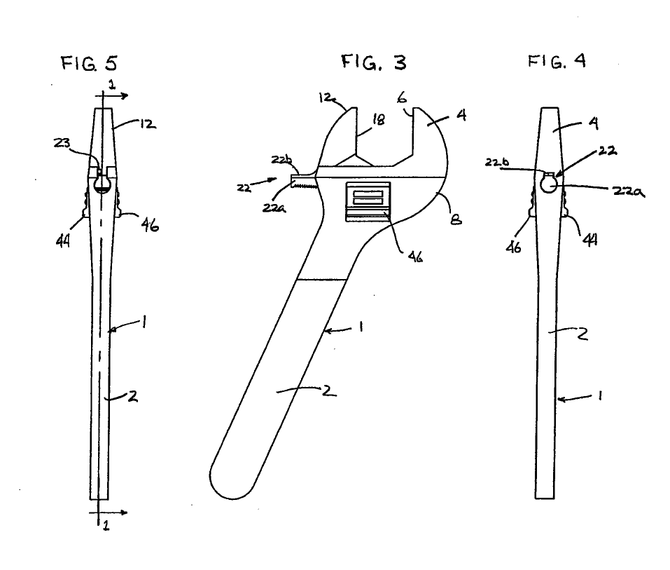

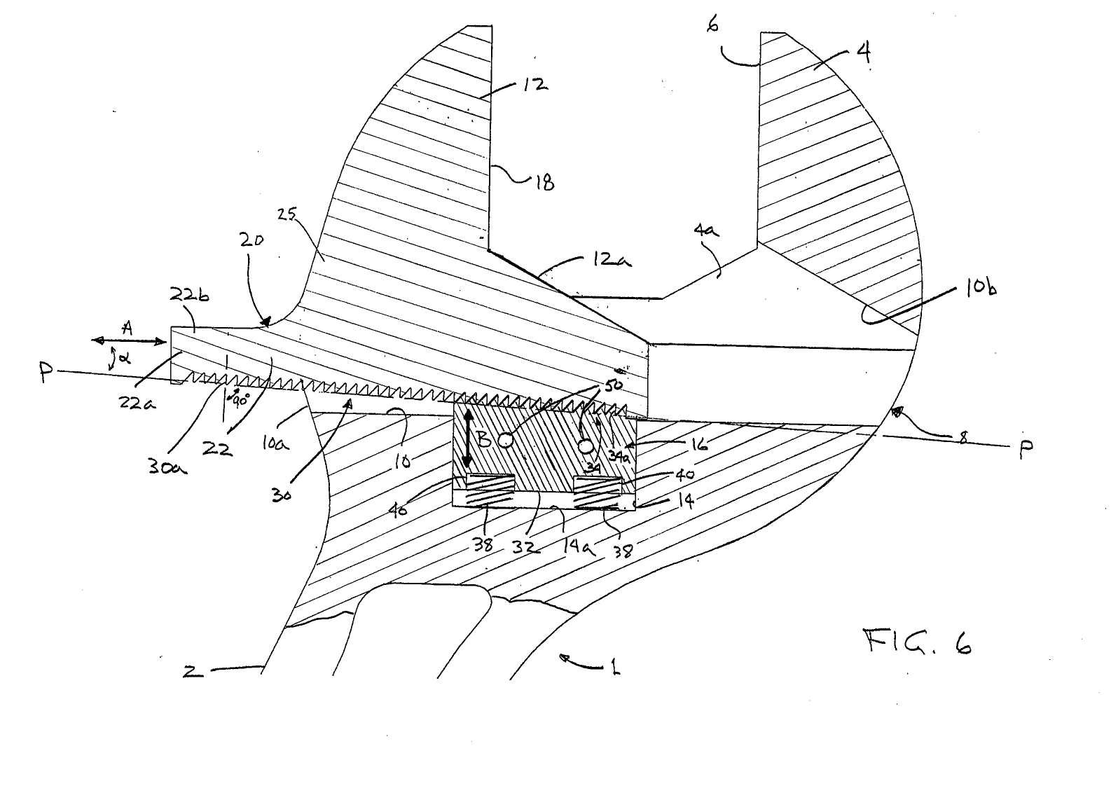

The wrench of the invention is shown in FIGS. 1 through 6 and consists of a body 1 that includes a handle 2 that supports a fixed jaw 4 such that the position of jaw 4 relative to handle 2 is fixed. In one embodiment jaw 4 and handle 2 are formed integrally with one another from a single piece of material such as steel. Fixed jaw 4 is formed with an article engaging face or surface 6 that engages the article being gripped when the wrench is in use. The body 1 further includes a transition area 8 that connects handle 2 to fixed jaw 4 where the transition area includes a passage 10 for receiving movable jaw 12. Passage 10 is formed as a cavity in body 1 that extends transversely through transition area 8. Passage 10 communicates with a through hole 14 that retains the jaw locking mechanism 16 as will hereinafter be described.

Movable jaw 12 defines an article engaging face or surface 18 that engages the article being gripped when the wrench is in use. It will be appreciated that face 18 of movable jaw 12 and face 6 of fixed jaw 4 may be generally disposed parallel to one another, or the faces may be inclined with respect to one another, and are moved relative to one another to grip an article therebetween such that a rotational force can be applied to the article by applying a torque to handle 2. While faces 6 and 18 are shown as generally planar surfaces it will be appreciated that these faces may have other shapes or configurations depending on the specific function of the wrench and the shape of the article being gripped. For example faces 6 and 18 may be formed with gripping ridges or may be comprised of multiple surfaces disposed at angles relative to one another. Movable jaw 12 further includes an engagement portion 20 that is slidably received in passage 10 such that the movable jaw 12 is able to slide in the passage relative to the fixed jaw 4. Specifically, engagement portion 20 includes a rail 22 that fits into passage 10 such that it can slide within the passage in the direction of arrow A but prevents the movable jaw 12 from separating from the transition area 8. In one embodiment this is accomplished by making the rail 22 with a transverse cross-section that includes a relatively wider portion 22a connected to a relatively narrower portion 22b. Passage 10 has a mating transverse cross-section where rail can be slid into engagement with the passage through the open end 10a of passage 10. The engagement of the wider portion of the rail with the narrow portion of passage 10 keeps the rail from separating from the wrench body 1. Once the rail 22 is inserted in the passage 10, a pin 23 that engages a stop on the rail can be inserted to prevent the rail from sliding all the way out of passage 10. Pin 23 may be eliminated and the rail 22 prevented from separating from the passage 10 by providing a stop 27 (FIG. 1) at the end of the rail 22 where the stop engages the teeth 34 on block 32 to prevent the movable jaw from being completely separated from the wrench body.

Passage 10 is open at the top to allow the movable jaw 12, which is connected to rail 22, to extend from the passage. In the transition area adjacent the fixed jaw 4, the passage is formed as a through hole 10b that receives the movable jaw 12. Flanges 25 may be formed on either side of the jaw to ride on the wrench body adjacent the passage 10 to stabilize and reinforce the jaw.

Passage 10 defines the path of movement of movable jaw 12 relative to body 1. Specifically, rail 22 moves in passage 10 along the longitudinal axis of passage 10. Thus, the direction of movement of the movable jaw 12 is along an axis parallel to arrow A.

Rail 22 has an overall length approximately equal to the width of the wrench body in the transition area 8. Further movable jaw 12 may include a web portion 12a that cooperates with a similar web portion 4a on fixed jaw 4 to define a recess for receiving articles such as hex nuts and to reinforce the jaws. The through hole portion 10b of passage 10 is configured such that it can receive the rail 22 and web portion 12a when the movable jaw is moved to a closed position.

Referring to FIGS. 1 and 6, the side of the rail 22 opposite the movable jaw 12 is formed with a series of ratchet teeth 30. The teeth 30 are arranged such that the distal ends of the teeth are in a plane as represented by line P-P in FIG. 1 where the plane is at an oblique angle a of approximately less than 10 degrees, and approximately 3 degrees, with respect to the direction of movement of the movable jaw 12 (represented by arrow A). The engagement faces 30a of teeth 30 are perpendicular to the plane represented by line P-P such that they are at an angle of 3 degrees relative to the direction of travel of the movable jaw (represented by arrow A). Engagement faces 30a of teeth 30 are the faces of the teeth that engage mating teeth 34 formed on locking mechanism 16. The distance between the teeth and the number of teeth used may be selected such that the spacing between jaws 4 and 12 corresponds to standard English or metric units or other desired dimensions.

Locking mechanism 16 consists of a block 32 slidably located in cavity or through hole 14 such that it can reciprocate in through hole 14. Specifically, block 32 can move in a direction represented by arrow B that is approximately perpendicular to the direction of movement of movable jaw 12 (represented by arrow A). Block 32 includes ratchet teeth 34 at the upper edge thereof that are dimensioned to mate with teeth 30 formed on rail 22. Teeth 34 include engagement faces 34a that meet with the engagement faces 30a to lock the movable jaw 12 in the desired position. Engagement faces 34a are parallel to engagement faces 30a. A pair of compression springs 38 are located between the block 32 and the face 14a of cavity or through hole 14 that bias the block towards rail 22 such that teeth 34 are biased into engagement with teeth 30. Springs 38 may be located in bores 40 formed in block 32. Block 32 is provided with a suitable length to width ratio such that the block will not pivot (counter-clockwise as viewed in FIG. 1) and inadvertently separate from rail 22 when in the locked position.

The back faces of teeth 30 and 34 are sloped such that the teeth can slide over one another in a ratcheting action when the movable jaw 12 is pushed toward jaw 4. The back face of the teeth 30 and 34 are the faces opposite the engagement faces 30a and 34a, respectively. The sloped teeth act as cams to push the block 32 away from the rail 22 as the teeth pass over one another.

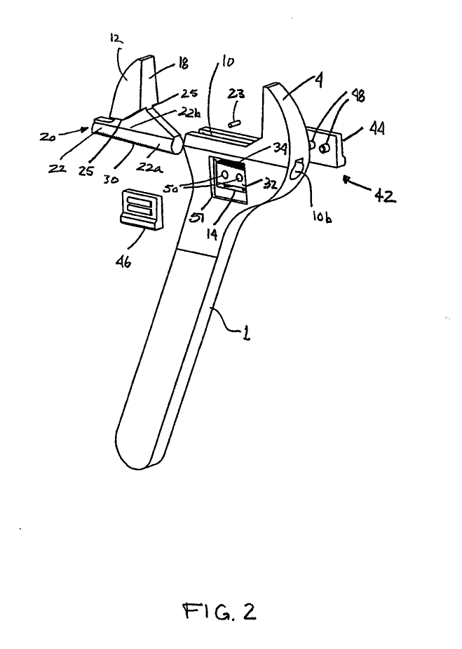

To retain block 32 and springs 38 in position cover plate/actuator button assembly 42 may be provided as shown in FIG. 2. Assembly 42 comprises a first cover plate/actuator button 44 located on one side of wrench body 1 and a second cover plate/actuator button 46 located on the opposite side of wrench body 1. The cover plate/actuators are dimensioned such that they may completely cover through hole 14 whether the block 32 is in the extended position engaged with rail 22 or in the retracted position disengaged from rail 22 or the teeth 30 may be accessible when the cover plate/actuators are in the retracted position to allow the user to inspect and clean the teeth. The cover plate/actuator buttons are connected to block 32 such as by posts 48 that extends from one cover plate/actuator button through holes 50 formed in block 32 and is press fit into a bore (not shown) in the opposite cover plate/actuator button. Other mechanisms may be used to connect the cover plate/actuator buttons 44 and 46 to the block 32 such as rivets, screws, adhesive, welding or the like. Moreover, one of the cover plates/actuator buttons could be integrally formed with block 32. Recesses 51 may be formed in the faces of body 1 to receive the cover plate/actuator buttons to minimize the extent they protrude from body 1.

Operation of the wrench will be explained. One of cover plate/actuator buttons 44 or 46 is moved in a direction towards handle 2 such that the teeth 34 of block 32 are disengaged from the teeth 30 of rail 22. Movable jaw 12 can then be moved away from fixed jaw 4 to a position where the distance between the jaws is large enough to receive the article to be gripped. The cover plate/actuator button is then released such that block 32 is moved towards rail 22 by springs 38. The user can then move movable jaw 12 toward jaw 4, by simply pushing jaw 12 toward jaw 4, until the article is gripped between the jaws. The engagement of teeth 34 of block 32 with teeth 30 of rail 22 lock the movable jaw 12 in the selected position to prevent the movable jaw 12 from moving away from jaw 4. A torque can then be applied to the article via handle 2.

Specific embodiments of an invention are disclosed herein. One of ordinary skill in the art will recognize that the invention has other applications in other environments. Many embodiments are possible. The following claims are in no way intended to limit the scope of the invention to the specific embodiments described above.

1. An adjustable wrench comprising:
a fixed jaw;
a movable jaw movable in a first direction;
a first series of teeth connected to the movable jaw and being disposed in a plane at an oblique angle relative to the first direction; and
a locking mechanism for locking the movable jaw in a selected position comprising a second series of teeth for engaging the first series of teeth, said first and second series of teeth having engaging faces that contact one another, the engaging faces being perpendicular to said plane.

2. The adjustable wrench of claim 1 wherein said oblique angle is less than 10 degrees.

3. The adjustable wrench of claim 1 wherein said oblique angle is about 3 degrees.

4. The adjustable wrench of claim 1 wherein said fixed jaw is connected to a handle.

5. The adjustable wrench of claim 1 wherein said fixed jaw and said handle are integrally formed.

6. The adjustable wrench of claim 1 wherein said fixed jaw includes a portion received in a passage.

7. The adjustable wrench of claim 6 wherein said portion can reciprocate in said passage in said first direction.

8. The adjustable wrench of claim 1 wherein said first and second series of teeth having second faces opposite top said engaging faces that contact one another to move said first series of teeth out of engagement with second series of teeth.

9. The adjustable wrench of claim 1 wherein said locking mechanism is biased such that the second series of teeth are biased into engagement with said first series of teeth.

10. The adjustable wrench of claim 6 wherein said locking mechanism is located in a cavity, said cavity communicating with said passage.

11. The adjustable wrench of claim 6 wherein said locking mechanism is located in a through hole, said through hole communicating with said passage.

12. The adjustable wrench of claim 1 wherein said first series of teeth can be disengaged from said second series of teeth to allow the movable jaw to move away from the fixed jaw.

13. The adjustable wrench of claim 9 further including an actuator operatively connected to the locking mechanism and adapted to by manually manipulated to disengage the first series of teeth from said second series of teeth to allow the movable jaw to move away from the fixed jaw.

14. An adjustable wrench comprising:
a fixed jaw;
a movable jaw movable in a first direction;
a first plurality of teeth connected to the movable jaw and being disposed in a plane at an oblique angle relative to the first direction; and
a locking mechanism for locking the movable jaw in a selected position comprising a second plurality of teeth for engaging the first plurality of teeth, said first and second plurality of teeth having engaging faces that contact one another to prevent the movable from moving away from the fixed jaw.

15. The adjustable wrench of claim 14 wherein said first plurality of teeth and said second plurality of teeth allow the movable jaw to move freely towards the fixed jaw.

16. The adjustable wrench of claim 15 wherein said movable jaw is moved towards said fixed jaw by pushing said movable jaw.

17. The adjustable wrench of claim 14 wherein the first plurality of teeth and the second plurality of teeth create a ratchet that allows the movable jaw to move freely towards the fixed jaw.

18. The adjustable wrench of claim 14 wherein the first plurality of teeth are manually movable away from the second plurality of teeth to allow the movable jaw to move freely away from the fixed jaw.

19. The adjustable wrench of claim 17 wherein the first plurality of teeth is biased into engagement with the second plurality of teeth.

20. A method of gripping an object with a wrench comprising:
providing a fixed jaw;
providing a movable jaw movable in a first direction;
providing a first series of teeth connected to the movable jaw and being disposed in a plane at an oblique angle relative to the first direction;
providing a locking mechanism for locking the movable jaw in a selected position comprising a second series of teeth biased into engagement with the first series of teeth, said first and second series of teeth having engaging faces that contact one another to prevent the movable from moving away from the fixed jaw, the engaging faces being perpendicular to said plane;
moving said locking mechanism against the bias to disengage said first series of teeth from said second series of teeth;
moving said movable jaw away from said fixed jaw while the first series of teeth are disengaged from said second series of teeth;
locating an object between said jaws;
releasing said locking mechanism to engage said first series of teeth with said second series of teeth;
moving said movable jaw toward said fixed jaw by pushing said movable jaw.
